(19) United States
(12) Patent Application Publication
(10) Pub. No.: US 2016/0288447 A1
(43) Pub. Date: Oct. 6, 2016

(54) Waterproof composite core

(71) Applicant: Eurico Januario Cordeiro, East Providence, RI (US)

(72) Inventor: Eurico Januario Cordeiro, East Providence, RI (US)

(21) Appl. No.: 14/677,066

(22) Filed: Apr. 2, 2015

(51) Int. Cl. B32B 3/06; B32B 27/30; B32B 27/40; B32B 27/20; B32B 27/32; E04C 2/24; B32B 29/00; B32B 9/02; E04F 15/02; E04F 15/10; E04F 13/08; E04F 13/16; B32B 27/06; B32B 21/08

(52) U.S. Cl. CPC B32B 3/06; B32B 27/06; B32B 27/304; B32B 27/40; B32B 27/20; B32B 27/32; B32B 21/08; B32B 29/002; B32B 9/025; E04F 15/02038; E04F 15/02188; E04F 15/107; E04F 13/0889; E04F 13/16; E04C 2/24; B32B 2250/03; B32B 2270/00; B32B 2272/00; B32B 2305/30; B32B 2307/73; B32B 2419/04; B32B 2607/00; E04F 2290/00

(57) ABSTRACT

A Glass Plastic Composite core material for floors and walls in the form of planks, tiles, wall panels and sheets made from recycled glass or glass, polyvinyl chloride and porcelain without containing wood fibers.

### CROSS REFERENCE TO RELATED APPLICATION

The present application is a continuation of U.S. application Ser. No. 14/589,878, filed Jan. 5, 2015.

### FIELD OF THE INVENTION

The invention relates to a waterproof composite core.

### BACKGROUND OF THE INVENTION

Moisture and water particularly in flooring is the most common problem when wood based products are installed in areas such as kitchens, bathrooms, basements and commercial applications.

Hardwood floors and high density wood fiber Laminate floors have been used for many years however moisture, water and other liquids destabilizes the wood fiber board allowing moisture to penetrate the core therefore not suitable for wet areas where moisture is present. Traditionally ceramic, porcelain and natural stone floors have been installed in moisture sensitive areas such as bathrooms, kitchens and basements in residential and commercial applications such as restaurants retail stores etc.

To address the issues of moisture the flooring manufactures have taken several approaches to minimize the negative effect of moisture and water on wood based products such as an attempt to protect the most vulnerable part of flooring planks or tiles the edges or joints by impregnating the joints-edges of wood based tiles and planks with a resin type sealer however tests have shown that resin alone without the use of PVC to be unsuccessful in protecting the flooring or wall core edges from moisture due to core composition containing wood based products.

Over the last twenty years flooring manufactures have made significant improvements such as easier installation methods and more resistant wear layers. However moisture in floors and wall panels tiles or planks continue to be a major problem for the industry. Recently new products to address the moisture of the core have been developed using as a composition based on PVC, limestone, and wood fibers from trees that are grounded into wood fibers, referred as Wood plastic composite (WPC) This composition does not resolve the moisture issues due to a high percentage of wood fibers in the WPC composition. The present Invention does not contain any wood fibers. The composition according to the invention combines recycled glass as the main mineral, sand in the form of silica in pre glass stage, PVC and plastic. Other advantages of recycled glass and sand-silica in pre glass stage do not contain moisture and do not emit volatile organic compounds (VOC) emissions. Unlike wood based that require the use of formaldehyde adhesive chemicals. Therefore the present invention adds another necessary advantage to address the industry's environmental requirements and contributes to LEED points. According to the present invention.

### SUMMARY OF THE INVENTION

The invention relates to a waterproof core plank, tile, wall panel and sheet panels or roll sheets for use in flooring and walls and to provide an environmental friendly product substituting wood based products with recycled glass and sand-silica in pre glass stage as follows. The core composition contains polyvinyl chloride, polyethylene, bonding agents, stabilizers, sand silica in the form of pre-glass stage, silica in the form of glass stage, recycled glass known as (common glass) in the form of dust, coarse particles or particles less then 3 mm in diameter. As referred wood plastic composite WPC contains a high percentage of wood fibers witch reduces the weight of the floor planks, tiles and panels, to address this and possibly reduce the weight a process called pre-expansion by submission to microwave radiation that it is performed in continuous or non-continuous mode and therefore reduce the weight of the sand-silica and recycled glass by expanding the sand-silica and recycled glass granulates or particles inferior to 3 mm in diameter.

According to the invention the waterproof core with said composition provide a core that does not contain any wood fibers. Said composition, recycled glass and sand-silica in pre-glass stage do not emit VOC'S and is environmentally friendly contributing highly to LEED certification points.

### DESCRIPTION OF THE DRAWINGS

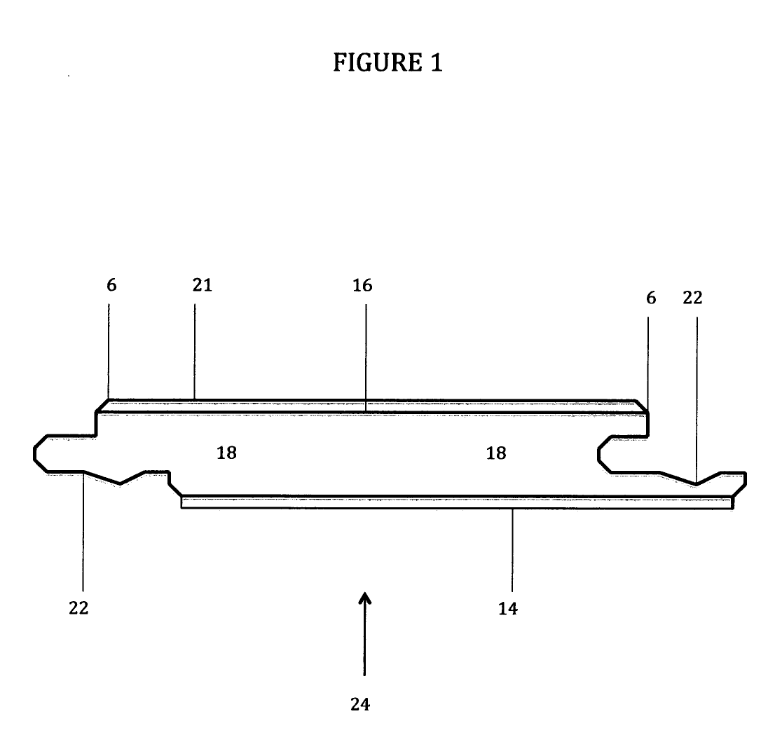

According to the invention FIG. 1, illustrates a view of a waterproof floor plank, tile, wall panel 24, illustrating a core 18 with a thickness from 3 mm to 12 mm. Comprising a protective polyurethane based wear layer 21. A decorative layer 16 having a thickness from 0.02 mm to 8 mm. A underlayment layer 14 with a thickness between 0.3 mm and 4 mm. Comprising a mechanical locking system 22. And comprising a beveled edge 6 on at least 2 edges of a plank, tile or wall panel.

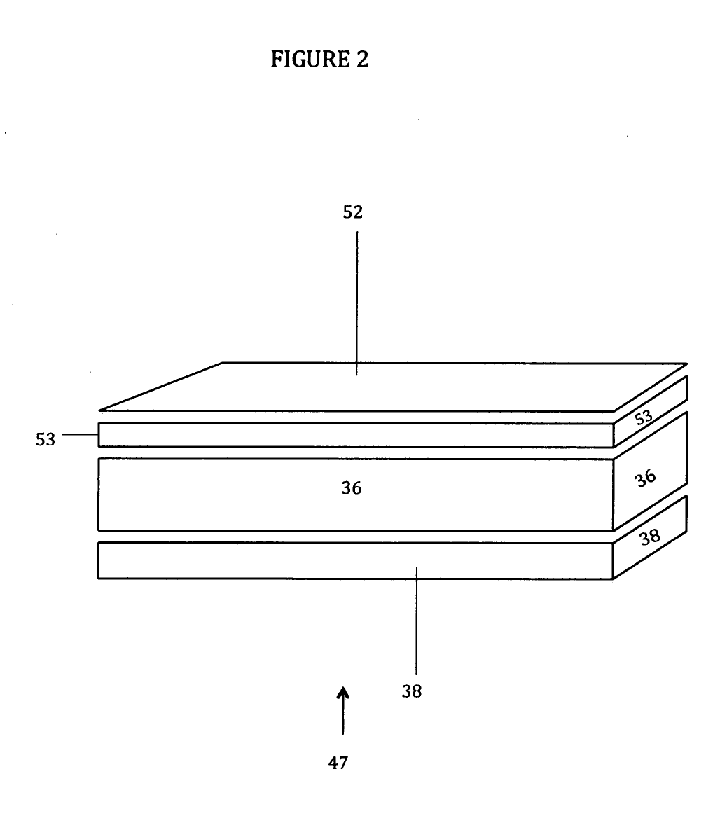

According to the invention FIG. 2, illustrates a view of a waterproof floor plank, tile, wall, illustrating a core 89 with a thickness from 3 mm to 12 mm. Comprising a protective polyurethane based wear layer 121. A decorative layer 110 having a thickness from 0.02 mm to 8 mm. A underlayment layer 19 with a thickness between 0.3 mm and 4 mm. Comprising a tongue and groove configuration 171,172. And comprising a beveled edge 60 on at least 2 edges of a plank, tile or wall panel.

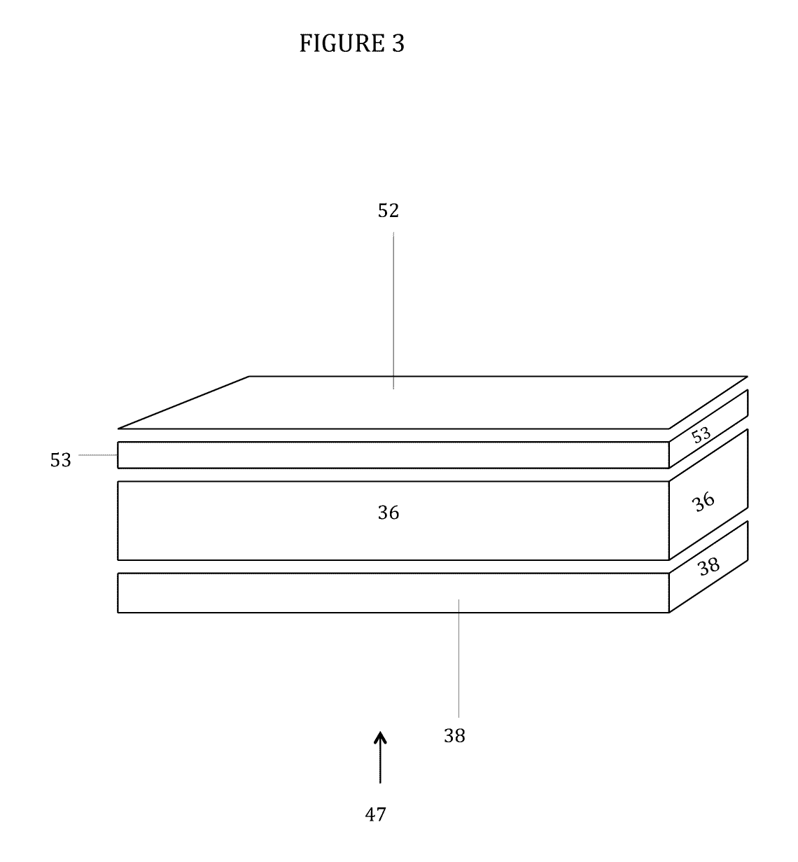

According to the invention FIG. 3, illustrates a view of a flexible or ridged sheet or panel 47 with dimensions grater than 300 mm in length and 300 mm in width comprising a core 36 with a thickness between 1.6 mm to 12 mm. FIG. 3 also illustrates a wear layer 52 consisting of a polyurethane based. A decorative layer 53 with a thickness between 0.02 mm to 4 mm. A underlayment layer 38 with a thickness from 0.3 mm to 4 mm with 90° (degree) edges.

### DETAILED DESCRIPTION OF THE INVENTION

According to FIG. 1, illustrates a ridged or flexible waterproof core 18 in the form of planks, tiles and wall panels 24. For flooring and wall applications with a thickness between 3 mm and 12 mm. FIG. 1 illustrates the core 18 with a composition consisting, of at least 42% of recycled glass or silica in pre-glass stage (sand) also sometimes called soda-lime-silica glass at least 16% of virgin or recycled polyvinyl chloride PVC, polyethylene, plastic, at least 3% of bonding agents, stabilizers and colorants. FIG. 1 also illustrates a polyurethane based wear layer with micro ceramic or aluminum oxide scratch resistance protection 21. FIG. 1 also illustrates a decorative layer 16 adhered to the upper side of the core 18 consisting of PVC, wood, wood veneer, natural stone, porcelain, cork, bamboo, linoleum, bonded leather, High Definition Printing HDP, vinyl and decor paper, with a thickness from 0.02 mm to 8 mm. FIG. 1 also illustrates a underlayment 14 adhered to the underside of the core 18 consisting of PVC, cork or rubber with a thickness between 0.3 mm and 4 mm. FIG. 1 also illustrates a micro-beveled edge 6 on one or more edges of the plank 24. For installation purposes the waterproof core 18 comprises of a mechanical locking system 22 that known to be licensed by VALINGE GROUP, UNILIN BEHEER BV, FLOORING INDUSTRIES LIMITED, SARL. Recognized to facilitate the installation of floating floors without the use of adhesives. Composition materials used as part of the core 18 are mixed by mechanical means and extruded into flooring planks, tiles and wall panels creating a ridged or flexible core 18.

According to FIG. 2, illustrates a ridged or flexible waterproof core 89 in the form of planks, tiles and wall panels 27. For flooring and wall applications with a thickness between 3 mm and 12 mm. FIG. 2 illustrates the core 89 with a composition consisting, of at least 42% of recycled glass or silica in pre-glass stage (sand) also sometimes called soda-lime-silica glass at least 16% of virgin or recycled polyvinyl chloride PVC, polyethylene, plastic, at least 3% of bonding agents, stabilizers and colorants. FIG. 2 also illustrates a polyurethane based wear layer with micro ceramic or aluminum oxide scratch resistance protection 121. FIG. 2 also illustrates a decorative layer 110 adhered to the upper side of the core 89 consisting of PVC, wood, wood veneer, natural stone, porcelain, cork, bamboo, linoleum, bonded leather, High Definition Printing HDP, vinyl and decor paper, with a thickness from 0.02 mm to 8 mm. FIG. 2 also illustrates a underlayment 19 adhered to the underside of the core 89 consisting of PVC, cork or rubber with a thickness between 0.3 mm and 4 mm. FIG. 2 also illustrates a micro-beveled edge 60 on one or more edges of the plank 27. For installation purposes the waterproof core 89 comprises a tongue and groove configuration 171,172. Composition materials used as part of the core 89 are mixed by mechanical means and extruded into flooring planks, tiles and wall panels creating a ridged or flexible core 89.

According to FIG. 3, a flexible or ridged waterproof core 36 with a thickness between 1.6 mm and 12 mm for flooring and wall applications. FIG. 3 illustrates the core 36 with a composition consisting, at least 42% of recycled glass or silica in pre-glass stage (sand) also sometimes called soda-lime-silica glass at least 16% of virgin or recycled polyvinyl chloride PVC, polyethylene, plastic, at least 3% of bonding agents, stabilizers and colorants. FIG. 3 also illustrates a polyurethane based wear layer with micro ceramic or aluminum oxide scratch resistance protection 52. FIG. 3 also illustrates a decorative layer 53 adhered to the upper side of the core 89 consisting of PVC, cork and linoleum, vinyl with a thickness between 0.02 mm and 3 mm. FIG. 3 also illustrates a underlayment 38 adhered to the underside of the core 36 consisting of PVC, cork or rubber with a thickness between 0.3 mm and 4 mm consisting of a core sheet with 90° (degree) edges. Composition materials used as part of the core 89 are mixed by mechanical means and extruded into sheets creating a flexible or ridged core 36.

According to FIGS. 1 and 2 the planks, tiles and panels are generally rectangular shape width between 50 mm and 300 mm in length and for square shape length and width of 200 mm×200 mm.

According to FIG. 3 the core sheet 36 is flexible having dimensions in width and length greater than 300 mm×300 mm.

A general view of the invention is the composition of the core 18 and 89 for planks, tiles and panels and 36 for sheets. Combining recycled glass, polyvinyl chloride and silica in pre-glass stage (sand). Provides the flooring industry with a truly waterproof core that is environmental friendly and do not contain wood fibers therefore protecting the environment and contributing highly to LEED certification points. Another advantage of the present invention is that recycled glass silica in pre-glass stage do not emit (VOC'S) and is relatively inexpensive and abundantly available by municipalities and other organizations through their waste management recycling programs and silica in pre-glass stage is basically clean sand that is grounded to small particles. These three ingredients are then mixed by mechanical means and extruded into the desired thickness and dimensions.

1. A extruded waterproof core rigid or flexible for floor planks, tiles and wall panels and sheets, comprising:
(a) Core composition made from PVC, plastic, recycled glass, soda-lime-silica, (sand)-silica in pre-glass stage, (sand) bonding agents, stabilizers and colorants, with a thickness between 3 mm and 12 mm.
(b) Edges of waterproof core planks, tiles and wall panels shaped with a tongue and grove configuration.
(c) A decorative layer with a thickness from 0.02 mm to 8 mm adhered to the upper surface of the waterproof core.
(d) A polyurethane based protective wear layer applied over the decorative layer.
(e) Edges of waterproof core click locking system comprising of an angle, vertical and snap together locking configuration.
(f) Waterproof core sheets comprising of 90° (degree) edges with a thickness between 1.6 mm and 12 mm.

2. According to claim 1, waterproof planks, tiles, panels and sheet core composition composed of at least 42% of recycled glass or silica in pre-glass stage (sand) also sometimes called soda-lime-silica glass at least 16% of virgin or recycled polyvinyl chloride PVC, polyethylene, plastic, at least 3% of bonding agents, stabilizers and colorants.
(a) According to claim 1, planks, tiles, panels and sheets exposure to moisture results in swelling by dimensions above 0.01% and below 0.02%.
(b) According to claim 1, planks, tiles, panels and sheets wherein the waterproof core further comprises recycled glass.
(c) The plank of claim 1 wherein the waterproof core further comprises silica in pre-glass stage (sand) also sometimes called soda-lime-silica glass (sand)
(d) According to claim 1, planks, tiles and panels are generally rectangular in shape, width between 50 mm and 300 mm in length and for square in shape length and width of 200 mm×200 mm.
(e) According to claim 1, waterproof core composition is obtained by an extrusion process.

3. According to claim 1, a decorative layer adhered by hot melt to the upper surface of the core comprising of Cork, PVC, vinyl, linoleum, wood, wood veneer, porcelain, bamboo, High definition printing (HDP), decor paper, bonded leather, comprising a thickness between 0.02 mm to 8 mm adhered to the upper surface of the waterproof core.
(a) According to claim 1, A wear layer applied over the decorative layer consisting of a polyurethane based wear layer with micro ceramic or aluminum oxide
(b) An underlayment adhered by hot melt to the underside of the waterproof core consisting of PVC, cork or rubber with a thickness between 0.3 mm and 4 mm.
(c) According to claim 1, the waterproof core sheet is flexible or ridged having dimensions in width and length greater than 300 mm×300 mm.
(d) According to claims 1, 2, and 3, recycled glass and (sand) silica in the form of pre-glass stage comprise of particles and or granulates less then 3 mm in diameter.
